(19) United States
(12) Patent Application Publication
(10) Pub. No.: US 2007/0189175 A1
(43) Pub. Date: Aug. 16, 2007

(54) CAPTURE TIMING AND NEGOTIATION DATA WITH REPEAT COUNTS IN A NETWORKING DIAGNOSTIC COMPONENT

(75) Inventors: Kiranmai Vedanabhatla, San Jose, CA (US); Geoffrey T. Hibbert, San Jose, CA (US); Roumel R. Garcia, Vallejo, CA (US); Andrew J. Milne, Sierra Madre, CA (US)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(73) Assignee: Finisar Corporation, Sunnyvale, CA (US)

(21) Appl. No.: 11/675,045

(22) Filed: Feb. 14, 2007

Related U.S. Application Data
(60) Provisional application No. 60/773,515, filed on Feb. 14, 2006.

(51) Int. Cl. H04L 12/26

(52) U.S. Cl. 370/241

(57) ABSTRACT

A network diagnostic device or component that is placed in-line between two nodes in a network to compress network data traffic to preserve available memory space. The network diagnostic component receives a low speed signal pattern from a first node for communication with a second node. The low speed signal pattern may be received by a receive module. The low speed signal pattern includes one at least a first signal component. The network diagnostic component records the first signal component in a memory. The network diagnostic component also records in the memory a representation of at least one subsequent signal component that is the same as the first signal component. The network diagnostic component may then record the length of time of the first signal component and the subsequent signal component in the memory.

### CROSS-REFERENCE TO RELATED APPLICATIONS

This application claims the benefit of U.S. Provisional Application No. 60/773,515, filed Feb. 14, 2006, which is incorporated herein by reference in its entirety.

### BACKGROUND

Computer and data communications networks continue to proliferate due to declining costs, increasing performance of computer and networking equipment, and increasing demand for communication bandwidth. Communications networks—including wide area networks (“WANs”), local area networks (“LANs”), metropolitan area networks (“MANs”), and storage area networks (“SANS”)—allow increased productivity and use of distributed computers or stations through the sharing of resources, the transfer of voice and data, and the processing of voice, data and related information at the most efficient locations. Moreover, as organizations have recognized the economic benefits of using communications networks, network applications such as electronic mail, voice and data transfer, host access, and shared and distributed databases are increasingly used as a means to increase user productivity. This increased demand, together with the growing number of distributed computing resources, has resulted in a rapid expansion of the number of installed networks.

As the demand for networks has grown, network technology has developed to the point that many different physical configurations presently exist. Examples include Gigabit Ethernet (“GE”), 10 GE, Fiber Distributed Data Interface (“FDDI”), Fibre Channel (“FC”), Synchronous Optical Network (“SONET”), Serial Attached SCSI (“SAS”), Serial Advanced Technology Attachment (“SATA”), and InfiniBand networks. These networks, and others, typically conform to one of a variety of established standards, or protocols, which set forth rules that govern network access as well as communications between and among the network resources. Typically, such networks utilize different cabling systems, have different characteristic bandwidths and typically transmit data at different speeds. Network bandwidth, in particular, has been the driving consideration behind much of the advancements in the area of high speed communication systems, methods and devices.

For example, the ever-increasing demand for network bandwidth has resulted in the development of technology that increases the amount of data that can be pushed through a single channel on a network. Advancements in modulation techniques, coding algorithms and error correction have vastly increased the rates at which data can be transmitted across networks. For example, a few years ago, the highest rate that data could travel across a network was at about one Gigabit per second. This rate has increased to the point where data can travel across various networks such as Ethernet and SONET at rates as high as 10 gigabits per second, or faster.

As communication networks have increased in size, speed and complexity however, they have become increasingly likely to develop a variety of problems that, in practice, have proven difficult to diagnose and resolve. Such problems are of particular concern in light of the continuing demand for high levels of network operational reliability and for increased network capacity.

The problems generally experienced in network communications can take a variety of forms and may occur as a result of a variety of different circumstances. Examples of circumstances, conditions and events that may give rise to network communication problems include the transmission of unnecessarily small frames of information, inefficient or incorrect routing of information, improper network configuration and superfluous network traffic, to name just a few. Such problems are aggravated by the fact that networks are continually changing and evolving due to growth, reconfiguration and introduction of new network topologies and protocols. Moreover, new network interconnection devices and software applications are constantly being introduced and implemented. Circumstances such as these highlight the need for effective, reliable, and flexible diagnostic mechanisms.

### BRIEF SUMMARY

Embodiments disclosed herein relate to a network diagnostic device or component that is placed in-line between two nodes in a network to compress network data traffic to preserve available memory space. For example, the network diagnostic component receives a low speed signal pattern from a first node for communication with a second node. The low speed signal pattern may be received by a receive module. The low speed signal pattern includes at least a first signal component.

The network diagnostic component records the first signal component in a memory. The network diagnostic component also records in the memory a representation of at least one subsequent signal component that is the same as the first signal component. The network diagnostic component may then record the length of time of the first signal component and the subsequent signal component in the memory.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description that follows, and in part will be obvious from the description, or may be learned by the practice of the embodiments disclosed herein. The features and advantages of the embodiments disclosed herein may be realized and obtained by means of the instruments and combinations particularly pointed out in the appended claims. These and other features of the embodiments disclosed herein will become more fully apparent from the following description and appended claims, or may be learned by the practice of the embodiments disclosed herein as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a block diagram of a network including a network diagnostic component placed in-line between two nodes;

FIG. 2 illustrates a detailed view of a particular embodiment of the network diagnostic component of FIG. 1;

FIG. 3 illustrates a method for a network diagnostic component placed in-line between two nodes to compress an initialization signal to preserve available memory space; and

FIG. 4 illustrates Data burst and DC-Idle portions of various SAS and SATA OOB signals.

### DETAILED DESCRIPTION

The embodiments disclosed herein relate to a network diagnostic component or device that is placed in-line between a first and second node. The diagnostic component or device is used to compress network data traffic to preserve available memory space. For example, the first node may communicate with the second node using a low speed signal pattern that includes a first component. In some embodiments, the low speed signal pattern may be of the SAS/SATA protocols. The network diagnostic component may receive the low speed signal pattern and record the first signal component in a memory. The network diagnostic component may then record subsequent signal components that are the same as the first signal component in the memory. A timestamp of the length of time of the first and subsequent signal components is also recorded in the memory. In some embodiments, the generated records are displayed on a display device.

The embodiments disclosed herein may be practiced in networking systems, including the testing of high speed data transmission systems and components. Embodiments described herein may also be used in other contexts unrelated to testing systems and components and/or unrelated to high speed data transmission. An example networking system will first be described. Then, the operation in accordance with specific embodiments disclosed herein will be described. Note that as used herein the terms “first”, “second” and so forth are not intended to imply sequential ordering, but rather are intended to distinguish one element from another.

### Example Networking System

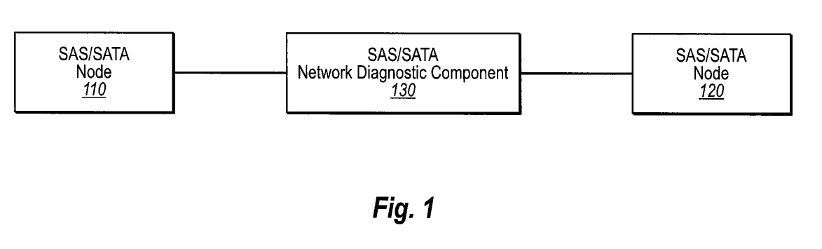

FIG. 1 is a block diagram of a networking system 100. The networking system 100 may include one or more nodes 110, 120, which communicate with each other via a network. As used herein, a “node” includes, but is not limited to, a server or host; a client or storage device; a switch; a hub; a router; all or a portion of a SAN fabric; a diagnostic device; and any other device or system, or combination thereof, that may be coupled to a network and that may receive and/or monitor a signal or data over at least a portion of a network, that may send and/or generate a signal or data over at least a portion of a network, or both.

In one embodiment, a signal (such as, an electrical signal, an optical signal, and the like) may be used to send and/or receive network messages over at least a portion of a network. As used herein, a “network message” or “network data stream” includes, but is not limited to, a packet; a datagram; a frame; a data frame; a command frame; an ordered set; any unit of data capable of being routed (or otherwise transmitted) through a computer network; and the like. In one embodiment, a network message or data stream may comprise transmission characters used for data purposes, protocol management purposes, code violation errors, and the like.

Also, an ordered set may include, a Start of Frame (“SOF”), an End of Frame (“EOF”), an Idle, a Receiver_Ready (“R_RDY”), a Loop Initialization Primitive (“LIP”), an Arbitrate (“ARB”), an Open (“OPN”), and Close (“CLS”)—such as, those used in certain embodiments of Fibre Channel. Of course, any ordered sets and/or any network messages of any other size, type, and/or configuration may be used, including, but not limited to, those from any other suitable protocols.

Nodes may communicate using suitable network protocols, including, but not limited to, serial protocols, physical layer protocols, channel protocols, packet-switching protocols, circuit-switching protocols, Ethernet, Fast Ethernet, Gigabit Ethernet, 10 Gigabit Ethernet, Fibre Channel, Fibre Channel Arbitrated Loop (“FC-AL”), Small Computer System Interface (“SCSI”), High Performance Parallel Interface (“HIPPI”), Serial Attached SCSI (“SAS”), Serial ATA (“SATA”), Serial SCSI Architecture (“SSA”), and the like. In this description and in the claims, protocol is defined to mean at least the speed at which the nodes communicate and the communication rules that are used by the nodes when communicating.

As shown in FIG. 1, the nodes 110,120 are preferably SAS/SATA nodes. As used herein, “SAS/SATA nodes” includes nodes that are SAS compatible, nodes that are SATA compatible, and nodes that are both SAS compatible and SATA compatible. It will be appreciated, however, that the nodes 110,120 need not be SATA/SATA nodes and that the nodes 110,120 may be other types of nodes that are compatible with other types of network protocols. In addition, any reference to a node as being a host or initiator node and another node as being a target node is for illustration only. It is contemplated that nodes 110, 120 can be both host and target nodes as circumstances warrant.

The networking system 100 may comprise a network, network diagnostic system, a network testing system, or the like including network diagnostic components (such as network diagnostic component 130), which may be configured to communicate network messages among nodes. For example, the network diagnostic component 130 may be inserted between the nodes 110,120 such that network messages sent between the nodes 110,120 are available to network diagnostic component 130 and/or are routed through the network diagnostic component 130.

In further detail, the network diagnostic component 130 may send and receive signals or data. Accordingly, using a signal, the network diagnostic component 130 may receive one or more network messages from a node, send one or more network messages to a node, or both. For example, the network diagnostic component 130 may receive one or more network messages sent between the nodes 110, 120. The network diagnostic component 130 may also retransmit those network messages. In particular, the network diagnostic component 130 may receive network messages sent from the node 110 and then retransmit them to the node 120. Also, the network diagnostic component 130 may receive network messages sent from the node 120 and then retransmit them to the node 110. As used herein, “in-line” denotes that a network diagnostic component is configured to have the network messages sent between two nodes routed to it so that the network messages are available to the network diagnostic component. In some embodiments the network diagnostic component may be directly in-line or it may be indirectly in-line through the use of a tap or like device. In still other embodiments, the network diagnostic component may have the network messages routed to it in any reasonable way.

Prior to retransmitting these network messages, the network diagnostic component 130 can modify the signal used to transmit the network messages. For example, the network diagnostic component 130 may digitally retime the signal, may modify the content of the messages themselves, or both. It will be appreciated that the network diagnostic component 130 may modify the signal in other desired ways. Because it is not always desirable to have the network diagnostic component 130 modify the signal, the network diagnostic component 130 may be selectively configured to modify (or not to modify) the signal used to transmit the network messages.

The network diagnostic component 130 may also perform a variety of network diagnostic functions using network messages sent between the nodes 110,120. In performing some of these diagnostic functions, the network diagnostic component 130 may be configured to be passive to the network messages. If desired, the network diagnostic component 130 may receive at least some of the network messages, and may transmit some or all of the received traffic. In performing other diagnostic functions, the network diagnostic component 130 may be configured to modify some or all of the network traffic.

As shown in FIG. 1, the network diagnostic component 130 is preferably a SAS/SATA network diagnostic component. As used herein, “SAS/SATA network diagnostic components” includes network diagnostic components that are SAS compatible, network diagnostic components that are SATA compatible, and network diagnostic components that are both SAS compatible and SATA compatible. It will be appreciated, however, that the network diagnostic component 130 need not be a SAS/SATA network diagnostic component and that the network diagnostic component 130 may be another type of network diagnostic component that is compatible with other types of network protocols. In fact, the network diagnostic component 130 may be configured to perform its functions on any type of network and/or network topology using any number of network protocols.

### Out-Of-Band Sequence and Speed Negotiation

In many applications, nodes 110 and node 120 may have periods of time when they communicate using a low speed signal pattern. Typically, the low speed signal patterns include full-amplitude data burst periods and zero amplitude common mode voltage periods where no data is transmitted. Such data patterns are “low speed” in the sense that they as generally slower than regular data transmission. A typical example of such a low speed signal pattern is the Out-of-Band signals common in such protocols as SAS and SATA. Of course, one skilled in the art will recognize that there are numerous other protocols with low speed signal patterns as described above.

Often, nodes 110 and 120 undergo an initialization process prior to communicating with each other. This initialization process allows the two nodes to agree upon the protocol (e.g., speed and/or communication rules) that the nodes will utilize while communicating with each other. As mentioned above, many nodes are configured to use both the SAS protocol and the SATA protocol. In such cases, it is often necessary during the initialization process for the nodes to specify whether they will be communicating using the SAS protocol or the SATA protocol.

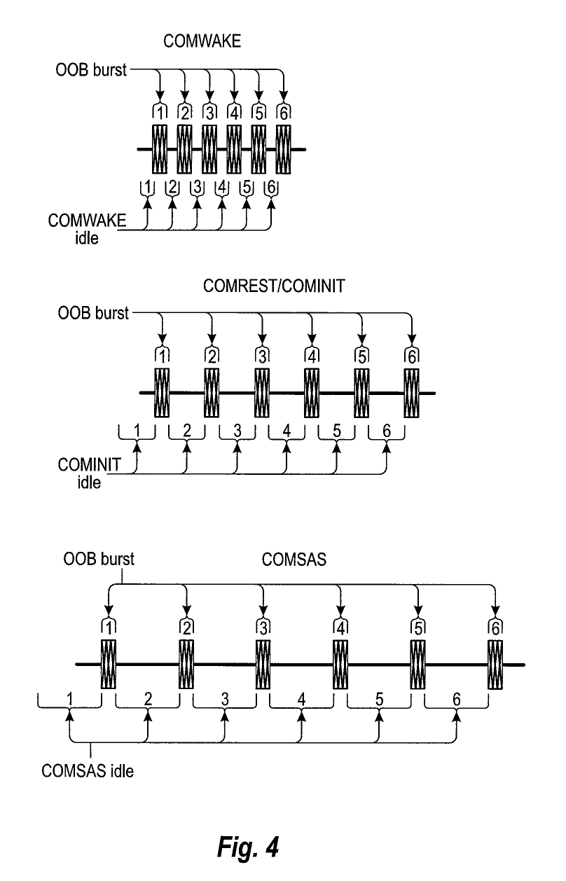

The communication rules are specified as part of the initialization process by low speed Out-Of-Band (OOB) signals that are defined by the SAS and SATA protocols. OOB signals constitute defined periods of DC-Idle (common mode voltage) followed by defined periods of Data bursts. The defined periods are specified by the SAS and SATA protocols. The Data burst period is the same for all the OOB signals. The DC-Idle period, however, varies and is used to differentiate between the different kinds of OOB signals. For example, the Data bursts and DC-Idles are defined in terms of an OOB Interval (OOBI), which at 1.5 Gigabits per second (Gbps) is nominally 666.666 picoseconds. The time periods for the Data bursts and DC-Idles of various SAS and SATA OOB signals are summarized in Table 1. A graphical representation of the Data burst and DC-Idle portions of the various SAS and SATA OOB signals is illustrated in FIG. 4.

TABLE 1

| Signal | Burst Time | DC-Idle Time |
|---|---|---|
| COMWAKE | 160 OOBI | 160 OOBI |
| COMINIT/COMRESET | 160 OOBI | 480 OOBI |
| COMSAS | 160 OOBI | 1440 OOBI |

Node 110, when desiring to utilize the SAS protocol, may send OOB signals designated as COMINIT/COMRESET (COMINIT/COMRESET are electrically identical signals) and COMSAS to node 120. As shown in Table 1 and FIG. 4, these OOB signals have defined Data burst periods and defined DC-idle periods that indicate the signal type. Upon receipt of these OOB signals, node 120 will be informed that node 110 desires to communicate using the SAS protocol. The node 120 may then respond appropriately.

In similar manner, if node 110 wishes to utilize the SATA protocol, it may send the COMINIT/COMRESET OOB signal and a COMWAKE OOB signal to node 120. As with the other OOB signals previously discussed, the COMWAKE signal also has defined Data burst periods and defined DC-idle periods as also shown in Table 1 and FIG. 4. Upon receipt of these OOB signals, node 120 will be informed that node 110 desires to communicate using the SATA protocol. The node 120 may then respond appropriately.

In some cases, node 110 may not know ahead of time which protocol node 120 may support. In those instances, node 110 may send all of the OOB signals to node 120. Node 120 will then recognize the OOB signals for the protocol that it is configured at that particular time to support and will respond to node 110 appropriately.

The speed of communication, on the other hand, is determined during a speed negotiation sequence that typically follows the OOB sequence. This consists of different speed negotiation windows that often begin at the lowest possible speed and then continue to higher speeds. For example, SAS/SATA nodes typically communicate at 1.5 Gbps, 3 Gbps, 6 Gbps, etc.

For example, in the SAS protocol, node 110 would first send a speed negotiation signal at 1.5 Gbps to node 120. If node 120 recognized the 1.5 Gbps speed negotiation signal, then node 110 would send a speed negotiation signal at 3 Gbps. If node 120 recognized the 3 Gbps speed negotiation signal, then node 110 would send a speed negotiation signal at 6 Gbps. This process would continue until either node 110 had reached its speed limit or there was a speed that node 120 did not recognize. In either case, the fastest speed supported by both nodes would be used.

In the SATA protocol, on the other hand, node 120, which is the SATA target in the illustrated embodiment, would send speed negotiation data at its highest speed first. If node 110 (the SATA host) could synchronize to this speed, then the speed is used. If node 110 could not synchronize, then node 120 would try its next lowest speed until a speed is found that node 110 could synchronize to. For example, node 120 would first send a speed negotiation signal at 6 Gbps. If node 110 could not synchronize to this speed, node 120 would send a speed negotiation signal at 3 Gbps. Note that although the above example was described in relation to using OOB signals in an initialization process, it understood that OOB signals may be sent by nodes 110 and 120 for other purposes as well. In addition, as previously mentioned, nodes 110 and 120 may also communicate using other types of low speed signal patterns as described above.

### Capture Timing and Negotiation Data with Repeat Counts

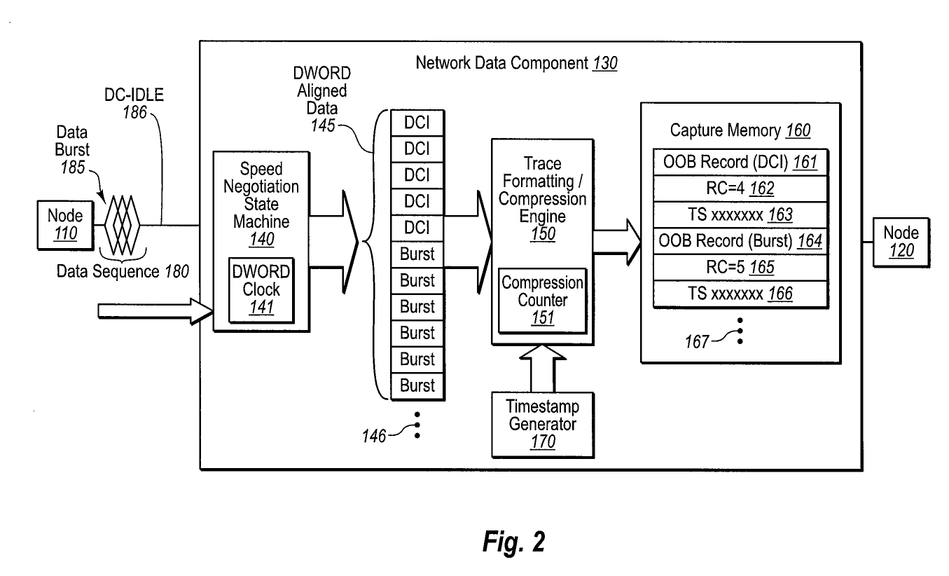

It is often the case, however, that a user of network 100 desires to analyze the timing of the Data burst and DC-Idle periods of a signal. This is done to ascertain that a proper signal is being received. In some network systems, every individual Dword that comprises a Data burst or DC-Idle is stored in a memory and then used to ascertain the timing of the signal. This approach can be costly in terms of available memory space as a large number of Dwords may require a large percentage of memory resources. Embodiments described herein allow for network diagnostic component 130 to ascertain the timing of the Data bursts and DC-Idles without having to store every individual Dword in memory. Such embodiments will be described with reference to FIG. 1, which was previously described, and FIG. 2, which shows a detailed view of one particular embodiment of network diagnostic component 130. Note that the embodiment of FIG. 2 is only one of numerous examples of a network diagnostic component 130 that can be used to implement the embodiments disclosed herein. Although the following embodiments will be described using the SAS and SATA protocols, this is by way of example only and should not be used to limit the scope of the appended claims. Other suitable protocols may also be utilized by the embodiments disclosed herein.

FIG. 2 shows that the embodiment of network diagnostic component 130 includes an Out-of-Band (OOB)/speed negotiation state machine 140, a trace formatting/compression engine 150, a capture memory 160, and a timestamp generator 170. Capture memory 160 may be a buffer in some embodiments and may also be any other type of suitable non-persistent and persistent memory source in other embodiments.

The OOB/speed negotiation state machine 140 may be implemented as any reasonable state machine. The OOB/Speed Negotiation State Machine 140 samples an incoming OOB sequence 180 from the wire using an internal Dword clock 141. The data sequence 180 is made up of Data bursts 185 and DC Idles 186 which may correspond to the Data bursts and DC-idles discussed previously in relation to FIG. 4 and Table 1. Of course, data sequence 180 may also correspond to other low speed signal patterns as described herein.

The OOB/Speed Negotiation State Machine 140 then generates Dword aligned data 145 that represents the DC-idles and Data burst Dwords that are detected from OOB sequence 180. As illustrated, Dword aligned data 145 includes an ellipses 146 that represents that any number of DC-idles and Data burst Dwords may be included in OOB sequence 180. The Dword aligned data 145 is then passed to the trace formatting/compression engine 150.

The trace formatting/compression engine 150 may be implemented as software, hardware, or any combination of software and hardware. The trace formatting/compression engine 150 is configured to compress the DC-Idles and Data burst Dwords of Dword aligned data 145 by counting the DC-Idles and Data burst Dwords and providing a count record to capture memory 160 as will be explained. The trace formatting/compression engine 150 is also configured provide for the insertion of a timestamp into the capture memory.

For example, trace formatting/compression engine 150 reads the first Dword or DC Idle in Dword aligned data 145 and writes the Dword or DC Idle to capture memory 160. Any subsequent Dwords or DC Idles that are the same as the first Dword are counted by a compression counter 151 inside the formatting/compression engine 150. A repeat count record is generated and written into the capture memory 160 when the trace formatting/compression engine 150 reads a Dword that is different from the preceding Dword. The count value of this repeat count record is the value of the compression counter 151. The compression counter 151 is reset to zero after the repeat count is written.

When the trace formatting/compression engine 150 reads the first Dword or DC Idle, it causes timestamp generator 170, which may be a counter in some embodiments, to begin counting. Timestamp generator 170 continues to count until trace formatting/compression engine 150 reads a new Dword or DC Idle. The resulting timestamp identifies the length of time from the first Dword or DC Idle to the new Dword or DC Idle inserted by trace formatting/compression engine 150 in capture memory 160 after the repeat count record gets written. The timestamp allows the accurate recreation of the DC-Idles and Data bursts that happened on the line. Use of the timestamp also allows a user of network diagnostic component 130 to ascertain how long the Data burst and DC-Idle periods lasted.

The new Dword or DC Idle is also written by trace formatting/compression engine 150 into the capture memory. Any subsequent Dwords or DC Idles that are the same will be counted and written into the memory 160 as described. A timestamp of this length of time will also be written as described. This process may continue any time a Dword or DC Idle that is different from a preceding Dword or DC Idle is read by trace formatting/compression engine 150.

A specific example will now be described. Note that the numbers of Dwords or DC Idles used in the example is for illustration only and should not be used to limit the scope of the appended claims. Referring to FIG. 2, Dword aligned data 145 includes 5 DC-Idles, labeled as DCI, followed by six Data burst Dwords, labeled as Burst. Trace formatting/compression engine 150 reads the first DCI and writes it into capture memory 160 as represented by 161. Since there are four DCIs that follow, trace formatting/compression engine 150 records 4 repeat counts from compression counter 151 in the capture memory as represented by 162. A timestamp 163 that records the length of time of the DCIs is generated by timestamp generator 170 and also written in the capture memory.

Following the DCIs are the six Data burst Dwords. Trace formatting/compression engine 150 takes the first Burst Dword and writes it into capture memory 160 as represented by 164. Since there are five Burst Dwords that follow, trace formatting/compression engine 150 records 5 repeat counts in the capture memory as represented by 165. A time stamp 166 is also generated by timestamp generator 170. Note that the capture memory 160 also includes ellipses 167 that illustrates that any number of additional OOB records may be recorded as necessary depending on the number of DC-Idles and Data burst Dwords in Dword aligned data 145.

The Data Burst Dword and or DC Idle data stored in the capture memory 160 by the method described above may then be displayed using an attached display device (not illustrated) or otherwise accessed by a user of network diagnostic component 130. This allows the user to verify that the timing of an OOB signal is as expected. If the timing of the signal is not as expected, then corrective action may be taken.

For example, the COMSAS OOB signal previously described typically contains DC-Idles followed by Data bursts, which typically are ALIGN primitives. The DC-Idle time for COMSAS is approximately 960 nanoseconds (ns) and the Data burst time is 120 ns. At 3 Gbps speed, the Dword granularity is typically 13.3 ns. Hence, the count for the DC-Idle time will be 72 Dwords. The count for the Align Data bursts will be 9 Dwords. From this, diagnostic component 130 is able to detect that a received signal 180 is a COMSAS signal. This may be displayed as shown in Table 2 below.

TABLE 2

| Timestamp | Count | Decode |
|---|---|---|
| T1 | 72 | DC-Idle |
| T2 | 2 | Data burst |
| T3 | 72 | DC-Idle |
| T4 | 2 | Data burst |
| T5 | 72 | DC-Idle |
| T6 | 2 | Data burst |
| T7 | 72 | DC-Idle |
| T8 | 2 | Data burst |
| T9 | 1 | COMSAS detected |

Speed negotiation data stored in the capture memory 160 may similarly be displayed and analyzed by a user. For example, during SAS speed negotiation, a SAS host/target has to transmit DC-Idles for approximately 500 μs. Then, if a first SAS device supports a particular speed, it has to transmit ALIGN0 data to a second SAS device and wait for ALIGN1 data in reply from the second SAS device. When the ALIGN1 data is received from the second SAS device, the first SAS device has to transmit ALIGN1 data back to the second SAS device. This process is indicated in table 3 below. The SAS device in the example supports 1.5 Gbps SAS speed (which is indicated has Successful G1 speed detected). The count numbers are based on the 13.3 ns per Dword granularity discussed above.

| Timestamp | Count | Decode |
|---|---|---|
| T1 | 37509 | DC-Idle |
| T2 | 6750 | Data burst ALIGN0 |
| T3 | 750 | Data burst ALIGN1 |
| T4 | 1 | Successful G1 speed |
| | | detected |

### Example Methods of Capture Timing and Negotiation Data with Repeat Counts

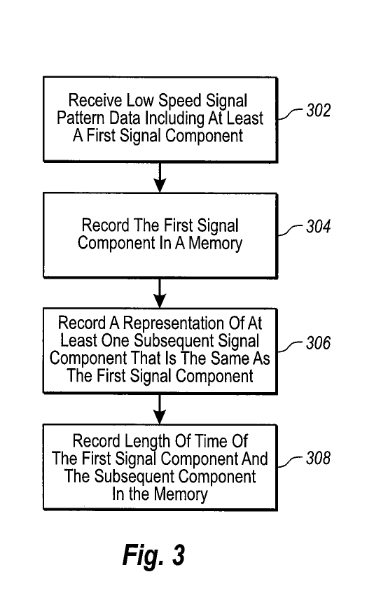

Referring now to FIG. 3, a flowchart of a method 300 for an in-line diagnostic component to compress an initialization signal to preserve available memory space is illustrated. Method 300 will be described in relation to the network system of FIGS. 1 and 2, although this is not required. It will be appreciated that method 300 may be practiced in numerous diagnostic network systems.

Method 300 includes an act of receiving a low speed signal pattern including at least a first signal component from a first node for communication with a second node (act 302). For example, network diagnostic component 130, specifically OOB/speed negotiation state machine 140, may receive OOB data sequence 180 from either node 110 or node 120, which may be SAS/SATA devices. As mentioned, the OOB signal data sequence 180 is one example of a low speed signal pattern, although other low speed signal patterns as described herein may also be received. OOB data sequence 180 may include both DC-Idles and Data burst Dwords. The first signal component may be either a DC-Idle or a Data burst Dword.

Method 300 also includes an act of recording a first signal component in a memory (act 304). For example, trace formatting/compression engine 150 may read the first DC Idle or Data burst Dword in Dword aligned data 145 and record the value in capture memory 160 as record 161. As illustrated, record 161 includes a DC-Idle, although a Data burst Dword or other signal component may also be recorded as record 161.

Method 300 further includes an act of recording a representation of at least one subsequent signal component that is the same as the first signal component in the memory (act 306). For example, network diagnostic component 130, which may be a SAS/SATA network component, may record a representation of the subsequent signal components that are the same as the first signal component is capture memory 160 as record 162. In some embodiments, this process is performed by a compression counter 151 in trace formatting/compression engine 150 that counts all Data burst Dwords or DC Idles that are the same as the first Data burst Dword or DC Idle recorded in act 304. The count record may then be recorded as record 162. Advantageously, recording a representation of the subsequent signal components that are the same as first signal component saves valuable capture memory space for other diagnostic component use, thus potentially decreasing costs and increasing efficiency.

Method 300 additionally includes an act of recording the length of time of the first signal component and the subsequent signal component in the memory (act 308). For example, network diagnostic component 130 may record the length of time of the signal components in record 163. In some embodiments, time stamp generator 170 generates a timestamp that is added by trace formatting/compression engine 150 to record memory 160 as record 163.

In some embodiments, the records of capture memory 160 may be displayed by a display device to inform a user of the comparison. The user may then take corrective action if necessary. In further embodiments, diagnostic component 130 may first measure and record the first signal components as described. The diagnostic component may then measure record a second signal component and subsequent signal components that are the same as the second signal component as was described previously.

### Example Network Diagnostic Functions

As mentioned above, the network diagnostic component 130 may perform a variety of network diagnostic functions. The network diagnostic component 130 may be configured to function as any combination of: a bit error rate tester, a protocol analyzer, a generator, a jammer, a monitor, and any other appropriate network diagnostic device.

### Bit Error Rate Tester

In some embodiments, the network diagnostic component 130 may function as a bit error rate tester. The bit error rate tester may generate and/or transmit an initial version of a bit sequence via a communication path. If desired, the initial version of the bit sequence may be user selected. The bit error rate tester may also receive a received version of the bit sequence via a communication path.

The bit error rate tester compares the received version of the bit sequence (or at least a portion of the received version) with the initial version of the bit sequence (or at least a portion of the initial version). In performing this comparison, the bit error rate test may determine whether the received version of the bit sequence (or at least a portion of the received version) matches and/or does not match the initial version of the bit sequence (or at least a portion of the initial version). The bit error tester may thus determine any differences between the compared bit sequences and may generate statistics at least partially derived from those differences. Examples of such statistics may include, but are not limited to, the total number of errors (such as, bits that did not match or lost bits), a bit error rate, and the like.

It will be appreciated that a particular protocol specification may require a bit error rate to be less than a specific value. Thus, a manufacturer of physical communication components and connections (such as, optical cables), communication chips, and the like may use the bit error rate tester to determine whether their components comply with a protocol-specified bit error rate. Also, when communication components are deployed, the bit error tester may be used to identify defects in a deployed physical communication path, which then may be physically inspected.

### Protocol Analyzer

In some embodiments, the network diagnostic component 130 may function as a protocol analyzer (or network analyzer), which may be used to capture data or a bit sequence for further analysis. The analysis of the captured data may, for example, diagnose data transmission faults, data transmission errors, performance errors (known generally as problem conditions), and/or other conditions.

As described below, the protocol analyzer may be configured to receive a bit sequence via one or more communication paths or channels. Typically, the bit sequence comprises one or more network messages, such as, packets, frames, or other protocol-adapted network messages. Preferably, the protocol analyzer may passively receive the network messages via passive network connections.

The protocol analyzer may be configured to compare the received bit sequence (or at least a portion thereof) with one or more bit sequences or patterns. Before performing this comparison, the protocol analyzer may optionally apply one or more bit masks to the received bit sequence. In performing this comparison, the protocol analyzer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence that comprises a network message having particular characteristics—such as, for example, having an unusual network address, having a code violation or character error, having an unusual timestamp, having an incorrect CRC value, indicating a link re-initialization, and/or having a variety of other characteristics.

The protocol analyzer may detect a network message having any specified characteristics, which specified characteristics may be user-selected via user input. It will be appreciated that a specified characteristic could be the presence of an attribute or the lack of an attribute. Also, it will be appreciated that the network analyzer may detect a network message having particular characteristics using any other suitable method.

In response to detecting a network message having a set of one or more characteristics, the network analyzer may execute a capture of a bit sequence—which bit sequence may comprise network messages and/or portions of network messages. For example, in one embodiment, when the network analyzer receives a new network message, the network analyzer may buffer, cache, or otherwise store a series of network messages in a circular buffer. Once the circular buffer is filled, the network analyzer may overwrite (or otherwise replace) the oldest network message in the buffer with the newly received network message or messages. When the network analyzer receives a new network message, the network analyzer may detect whether the network message has a set of one or more specified characteristics. In response to detecting that the received network message has the one or more specified characteristics, the network analyzer may execute a capture (1) by ceasing to overwrite the buffer (thus capturing one or more network messages prior to detected message), (2) by overwriting at least a portion or percentage of the buffer with one or more newly received messages (thus capturing at least one network message prior to the detected message and at least one network message after the detected message), or (3) by overwriting the entire buffer (thus capturing one or more network messages after the detected message). In one embodiment, a user may specify via user input a percentage of the buffer to store messages before the detected message, a percentage of the buffer to store messages after the detected message, or both. In one embodiment, a protocol analyzer may convert a captured bit stream into another format.

In response to detecting a network message having a set of one or more characteristics, a network analyzer may generate a trigger adapted to initiate a capture of a bit sequence. Also, in response to receive a trigger adapted to initiate a capture of a bit sequence, a network analyzer may execute a capture of a bit sequence. For example, the network analyzer may be configured to send and/or receive a trigger signal among a plurality of network analyzers. In response to detecting that a received network message has the one or more specified characteristics, a network analyzer may execute a capture and/or send a trigger signal to one or more network analyzers that are configured to execute a capture in response to receiving such a trigger signal. Further embodiments illustrating trigger signals and other capture systems are described in U.S. patent application Ser. No. 10/881,620 filed Jun. 30, 2004 and entitled PROPAGATION OF SIGNALS BETWEEN DEVICES FOR TRIGGERING CAPTURE OF NETWORK DATA, which is hereby incorporated by reference herein in its entirety

It will be appreciated that a capture may be triggered in response to detecting any particular circumstance—whether matching a bit sequence and bit pattern, receiving an external trigger signal, detecting a state (such as, when a protocol analyzer's buffer is filled), detecting an event, detecting a multi-network-message event, detecting the absence of an event, detecting user input, or any other suitable circumstance.

The protocol analyzer may optionally be configured to filter network messages (for example, network messages having or lacking particular characteristics), such as, messages from a particular node, messages to a particular node, messages between or among a plurality of particular nodes, network messages of a particular format or type, messages having a particular type of error, and the like. Accordingly, using one or more bit masks, bit patterns, and the like, the protocol analyzer may be used identify network messages having particular characteristics and determine whether to store or to discard those network messages based at least in part upon those particular characteristics.

The protocol analyzer may optionally be configured to capture a portion of a network message. For example, the protocol analyzer may be configured to store at least a portion of a header portion of a network message, but discard at least a portion of a data payload. Thus, the protocol analyzer may be configured to capture and to discard any suitable portions of a network message.

It will be appreciated that a particular protocol specification may require network messages to have particular characteristics. Thus, a manufacturer of network nodes and the like may use the protocol analyzer to determine whether their goods comply with a protocol. Also, when nodes are deployed, the protocol analyzer may be used to identify defects in a deployed node or in other portions of a deployed network.

### Generator

In some embodiments, the network diagnostic component 130 may function as a generator. The generator may generate and/or transmit a bit sequence via one or more communication paths or channels. Typically, the bit sequence comprises network messages, such as, packets, frames, or other protocol-adapted network messages. The network messages may comprise simulated network traffic between nodes on a network. In one embodiment, the bit sequence may be a predefined sequence of messages. Advantageously, a network administrator may evaluate how the nodes (and/or other nodes on the network) respond to the simulated network traffic. Thus, the network administrator may be able to identify performance deviations and take appropriate measures to help avoid future performance deviations.

In one embodiment, the generator may execute a script to generate the simulated network traffic. The script may allow the generator to dynamically simulate network traffic by functioning as a state machine or in any other suitable manner. For example, a script might include one or more elements like the following: “In state X, if network message A is received, transmit network message B and move to state Y.” The generator may advantageously recognize network messages (and any characteristics thereof) in any other suitable manner, including but not limited to how a protocol analyzer may recognize network messages (and any characteristics thereof). The script may also include a time delay instructing the generator to wait an indicated amount of time after receiving a message before transmitting a message in response. In response to receiving a message, a generator may transmit a response message that is completely predefined. However, in response to receiving a message, a generator may transmit a response message that is not completely predefined, for example, a response message that includes some data or other portion of the received message.

### Jammer

In some embodiments, the network diagnostic component 130 may function as a jammer. The jammer may receive, generate, and/or transmit one or more bit sequences via one or more communication paths or channels. Typically, the bit sequences comprise network messages (such as, packets, frames, or other protocol-adapted network messages) comprising network traffic between nodes on a network. The jammer may be configured as an inline component of the network such that the jammer may receive and retransmit (or otherwise forward) network messages.

Prior to retransmitting the received network messages, the jammer may selectively alter at least a portion of the network traffic, which alterations may introduce protocol errors or other types of errors.

By altering at least a portion of the network traffic, the jammer may generate traffic, which traffic may be used to test a network. For example, a network administrator may then evaluate how the nodes on the network respond to these errors. For example, a network system designer can perform any one of a number of different diagnostic tests to make determinations such as whether a system responded appropriately to incomplete, misplaced, or missing tasks or sequences; how misdirected or confusing frames are treated; and/or how misplaced ordered sets are treated. In some embodiments, the network diagnostic component 130 may include any suitable jamming (or other network diagnostic system or method) disclosed in U.S. Pat. No. 6,268,808 B1 to Iryami et al., entitled HIGH SPEED DATA MODIFICATION SYSTEM AND METHOD, which is hereby incorporated by reference herein in its entirety.

In one embodiment, to determine which network messages to alter, the jammer may be configured to compare a received bit sequence—such as a network message—(or a portion of the received bit sequence) with one or more bit sequences or patterns. Before performing this comparison, the jammer may optionally apply one or more bit masks to the received bit sequence. In performing this comparison, the jammer may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises a network message from a particular node, a message to a particular node, a network message between or among a plurality of particular nodes, a network message of a particular format or type, and the like. Accordingly, the jammer may be configured to detect a network message having any specified characteristics. Upon detection of the network message having the specified characteristics, the jammer may alter the network message and/or one or more network messages following the network message.

### Monitor

In some embodiments, the network diagnostic component 130 may function as a monitor, which may be used to derive statistics from one or more network messages having particular characteristics, one or more conversations having particular characteristics, and the like.

As described below, the monitor may be configured to receive a bit sequence via one or more communication paths or channels. Typically, the monitor passively receives the network messages via one or more passive network connections.

To determine the network messages and/or the conversations from which statistics should be derived, the monitor may be configured to compare a received a bit sequence—such as a network message—(or a portion of the received bit sequence) with one or more bit sequences or patterns. Before performing this comparison, the monitor may optionally apply one or more bit masks to the received bit sequence. In performing this comparison, the monitor may determine whether all or a portion of the received bit sequence (or the bit-masked version of the received bit sequence) matches and/or does not match the one or more bit patterns. In one embodiment, the bit patterns and/or the bit masks may be configured such that the bit patterns will (or will not) match with a received bit sequence (or portion thereof) when the received bit sequence comprises a network message from a particular node, a network message to a particular node, a network message between or among a plurality of particular nodes, a network message of a particular format or type, a network message having a particular error, and the like. Accordingly, the monitor may be configured to detect a network message having any specified characteristics—including but not limited to whether the network message is associated with a particular conversation among nodes.

Upon detecting a network message having specified characteristics, the monitor may create and update table entries to maintain statistics for individual network messages and/or for conversations comprising packets between nodes. For example, a monitor may count the number of physical errors (such as, bit transmission errors, CRC error, and the like), protocol errors (such as, timeouts, missing network messages, retries, out of orders), other error conditions, protocol events (such as, an abort, a buffer-is-full message), and the like. Also, as an example, the monitor may create conversation-specific statistics, such as, the number of packets exchanged in a conversation, the response times associated with the packets exchanged in a conversation, transaction latency, block transfer size, transfer completion status, aggregate throughput, and the like. It will be appreciated that a specified characteristic could be the presence of an attribute or the lack of an attribute.

In some embodiments, the network diagnostic component 130 may include any features and/or perform any method described in U.S. patent application Ser. No. 10/769,202, entitled MULTI-PURPOSE NETWORK DIAGNOSTIC MODULES and filed on Jan. 30, 2004, which is hereby incorporated by reference herein in its entirety

### Example Systems

It will be appreciated that the network diagnostic component 130 may be used to implement a variety of systems.

In one embodiment, the network diagnostic component 130 may comprise a printed circuit board. The printed circuit board may include a CPU module.

In one embodiment, the network diagnostic component 130 may comprise a blade. The blade may include a printed circuit board, an interface, or any combination thereof.

In one embodiment, the network diagnostic component 130 may comprise a chassis computing system. The chassis computing system may include one or more CPU modules, which may be adapted to interface with one, two, or more blades or other printed circuit boards. For example, a blade may have an interface though which a diagnostic module may send network diagnostic data to a CPU module of the chassis computing system. The chassis computer system may be adapted to receive one or more printed circuit boards or blades.

A CPU module may transmit the network diagnostic data it receives to a local storage device, a remote storage device, or any other suitable system for retrieval and/or further analysis of the diagnostic data. A client software program may retrieve, access, and/or manipulate the diagnostic data for any suitable purpose. Examples of systems and methods for storing and retrieving network diagnostic data include, but are not limited to, those described in U.S. patent application Ser. No. 10/307,272, entitled A SYSTEM AND METHOD FOR NETWORK TRAFFIC AND I/O TRANSACTION MONITORING OF A HIGH SPEED COMMUNICATIONS NETWORK and filed Nov. 27, 2002, which is hereby incorporated by reference herein in its entirety.

In one embodiment, the network diagnostic component 130 may comprise an appliance. Depending on the particular configuration, the appliance may include any suitable combination of one or more CPU modules and one or more diagnostic modules. In one embodiment, an appliance may include and/or be in communication with one or more storage devices, which may advantageously be used for storing any suitable diagnostic data, statistics, and the like. In one embodiment, an appliance may include and/or be in communication with one or more client interface modules, which may advantageously be used for displaying information to a user, receiving user input from a client software program, sending information to a client software program, or both. The appliance may also include and/or be in communication with one or more display devices (such as, a monitor) adapted to display information, one or more user input devices (such as, a keyboard, a mouse, a touch screen, and the like) adapted to receive user input, or both.

It will be appreciated that the network diagnostic component 130 may comprise any of a variety of other suitable network diagnostic components.

### Example Operating and Computing Environments

The methods and systems described above can be implemented using software, hardware, or both hardware and software. For example, the software may advantageously be configured to reside on an addressable storage medium and be configured to execute on one or more processors. Thus, software, hardware, or both may include, by way of example, any suitable module, such as software components, object-oriented software components, class components and task components, processes, functions, attributes, procedures, subroutines, segments of program code, drivers, firmware, microcode, circuitry, data, databases, data structures, tables, arrays, variables, field programmable gate arrays (“FPGA”), a field programmable logic arrays (“FPLAs”), a programmable logic array (“PLAs”), any programmable logic device, application-specific integrated circuits (“ASICs”), controllers, computers, and firmware to implement those methods and systems described above. The functionality provided for in the software, hardware, or both may be combined into fewer components or further separated into additional components. Additionally, the components may advantageously be implemented to execute on one or more computing devices. As used herein, “computing device” is a broad term and is used in its ordinary meaning and includes, but is not limited to, devices such as, personal computers, desktop computers, laptop computers, palmtop computers, a general purpose computer, a special purpose computer, mobile telephones, personal digital assistants (PDAs), Internet terminals, multi-processor systems, hand-held computing devices, portable computing devices, microprocessor-based consumer electronics, programmable consumer electronics, network PCs, minicomputers, mainframe computers, computing devices that may generate data, computing devices that may have the need for storing data, and the like.

Also, one or more software modules, one or more hardware modules, or both may comprise a means for performing some or all of any of the methods described herein. Further, one or more software modules, one or more hardware modules, or both may comprise a means for implementing any other functionality or features described herein.

Embodiments within the scope of the present invention also include computer-readable media for carrying or having computer-executable instructions or data structures stored thereon. Such computer-readable media can be any available media that can be accessed by a computing device. By way of example, and not limitation, such computer-readable media can comprise any storage device or any other medium which can be used to carry or store desired program code means in the form of computer-executable instructions or data structures and which can be accessed by a computing device.

When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a computing device to perform a certain function or group of functions. Data structures include, for example, data frames, data packets, or other defined or formatted sets of data having fields that contain information that facilitates the performance of useful methods and operations. Computer-executable instructions and data structures can be stored or transmitted on computer-readable media, including the examples presented above.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for a network diagnostic component that is placed in-line between first and second nodes in a network to compress network data traffic to preserve available memory space, the method comprising:
an act of receiving a low speed signal pattern including at least a first signal component from the first node for communication with the second node;
an act of recording the first signal component in a memory; and
an act of recording a representation of at least one subsequent signal component that is the same as the first signal component in the memory.

2. A method in accordance with claim 1 further comprising:
an act of recording the length of time of the first signal component and the subsequent signal component in the memory.

3. A method in accordance with claim 2, further comprising:
an act of displaying the length of time record on a display device.

4. The method in accordance with claim 1, wherein the network diagnostic component is a SAS/SATA network diagnostic component.

5. The method in accordance with claim 1, wherein the first signal component is one of a full-amplitude data burst component or one of a zero amplitude component.

6. The method in accordance with claim 1, wherein the first signal component is one of Data bursts or DC-Idle.

7. The method in accordance with claim 1, wherein the low speed signal pattern further includes a second signal component that is different from the first signal component, the method further comprising:
an act of recording the second signal component in the memory;
an act of recording a representation of at least one signal component that is subsequent to the second component and is the same as the second component in the memory; and
an act of recording the length of time of the second signal component and the subsequent signal component that is the same as the second signal component in the memory.

8. The method in accordance with claim 7, wherein the second component is one of Data bursts or DC-Idle.

9. The method in accordance with claim 7, wherein the second component is one of is one of a full-amplitude data burst component or one of a zero amplitude component.

10. The method in accordance with claim 1, wherein the act of recording a representation of at least one subsequent signal component that is the same as the first signal component in the memory comprises:
an act of counting the at least one signal component that is the same as the first signal component to produce a count record; and
an act of recording the count record in the memory.

11. A network diagnostic device placed in-line between first and second nodes in a network comprising:
a first module configured to receive a low speed signal pattern from the first node for communication with the second node, wherein the low speed signal pattern includes at least a first signal unit;
a second module configured to record the first signal unit in a memory;
a third module configured to generate a representation to be recorded in the memory of at least one subsequent signal unit that is the same as the first signal unit; and
a fourth module configured to generate a record to be recorded in the memory of the length of time of the first signal unit and the subsequent signal unit.

12. The network diagnostic device in accordance with claim 11, wherein the low speed signal pattern further includes a second signal unit that is different from the first signal unit, the network diagnostic device further comprising:
the second module further configured to record the second signal unit in the memory;
the third module further configured to generate a representation to be recorded in the memory of at least one signal unit that is subsequent to the second signal unit and is the same as the second signal component; and
the fourth module further configured to generate a record to be recorded in the memory of the length of time of the second signal unit and the subsequent signal unit that is the same as the second signal unit.

13. The network diagnostic device in accordance with claim 12, wherein the second signal unit is one of Data bursts or DC-Idle.

14. The network diagnostic device in accordance with claim 12, wherein the second signal unit one of is one of a full-amplitude data burst component or one of a zero amplitude component.

15. The network diagnostic device in accordance with claim 11, wherein the generated record is displayed on a display device coupled to the network diagnostic device.

16. The network diagnostic device in accordance with claim 11, wherein the first module is an OOB/speed negotiation state machine.

17. The network diagnostic device in accordance with claim 11, wherein the second module is a trace formatting/compression engine.

18. The network diagnostic device in accordance with claim 11, wherein the third module is a compression counter.

19. The network diagnostic device in accordance with claim 11, wherein the fourth module is a timestamp generator.

20. The network diagnostic device in accordance with claim 11, wherein the first and second nodes are SAS/SATA nodes and the network diagnostic component is a SAS/SATA network component.

21. The network diagnostic device in accordance with claim 11, wherein the network diagnostic device is one of a bit error rate tester, a protocol analyzer, a generator, a jammer, and a monitor.

22. The network diagnostic device in accordance with claim 11, wherein the first signal unit is one of Data bursts or DC-Idle.

23. The network diagnostic device in accordance with claim 11, wherein the first signal unit is one of a full-amplitude data burst component or one of a zero amplitude component.

24. A diagnostic network comprising:
a first node;
a second node;
a network diagnostic device placed in-line between the first and second nodes comprising:
a first module configured to receive a low speed signal pattern from the first node for communication with the second node, wherein the low speed signal pattern includes at least a first signal component;
a second module configured to record the first signal component in a memory;
a third module configured to generate a representation to be recorded in the memory of at least one subsequent signal component that is the same as the first signal component; and
a fourth module configured to generate a record to be recorded in the memory of the length of time of the first signal component and the subsequent signal component.

25. The diagnostic network in accordance with claim 24, wherein the first signal component is one of initialization Data bursts or DC-Idle data.

26. The diagnostic network in accordance with claim 24, wherein the first and second nodes are SAS/SATA nodes and the network diagnostic device is a SAS/SATA network component.
